(19) United States
(12) Patent Application Publication
(10) Pub. No.: US 2009/0031611 A1
(43) Pub. Date: Feb. 5, 2009

(54) MONITOR AND BAIT DELIVERY SYSTEM FOR INSECTS

(76) Inventor: James Traniello, Lexington, MA (US)

Correspondence Address: RONALD I. EISENSTEIN, 100 SUMMER STREET, NIXON PEABODY LLP, BOSTON, MA, 02110, US

(21) Appl. No.: 12/183,454

(22) Filed: Jul. 31, 2008

Related U.S. Application Data
(60) Provisional application No. 60/962,683, filed on Jul. 31, 2007.

(51) Int. Cl. A01M 1/00

(52) U.S. Cl. 43/124

(57) ABSTRACT

The invention relates to an apparatus for monitoring, trapping, and baiting of insect fauna in an environment. The invention also relates to an apparatus for pest control of insect pest.

### CROSS REFERENCE TO RELATED APPLICATIONS

This application claims benefit under 35 U.S.C. § 119(e) of the U.S. Provisional application No. 60/962,683 filed Jul. 31, 2007, the contents of which are incorporated herein by reference in its entirety.

### BACKGROUND OF INVENTION

The control and elimination of subterranean termites and ants from human habitation is of special concern because their daily foraging activities, if left unchecked, can lead to severe damage to buildings and structures, and cause enormous property damage. Termites alone cause nearly $2-billion in damage annually and most homeowner and property insurance policies do not cover termite damages. Therefore, there is an ongoing need for monitoring, controlling, and eliminate termite and ant colonies.

Various strategies have been used to monitor, control, and eliminate termites and ants and other wood-destroying insects in surrounding environments of human dwellings. One such strategy is the blanket application of chemical pesticide in the soil beneath and around dwellings to be protected. Unfortunately, this can increase environmental pesticide load and result in contamination of soil, water, and the killing of beneficial insects and other soil organisms, as well as the incidental poisoning of non target animals, humans and pets. Moreover, with the recent environmental regulations aimed at protecting and preserving our environment, this strategy is less desirable.

Currently, there are a number of advances in the strategy for targeted delivery of pesticide chemicals and surveillance of subterranean termites (U.S. Pat. Nos. 5,329,726, 5,815,090, 6,343,434, 6,631,583, 6,772,557, 6,857,223, US Patent Application Nos.: 2001/0009399 and 2004/0140900), and several commercial termite control systems such as the SENTRICON™ system of DOW Agroscience (Indianapolis, Ind.) and the ADVANCE™ termite bait system by Whitmire Micro-Gen (St. Louis, Mo.). These termite systems is made up of several termite monitoring-cum-bait units places strategically in the grounds around the building to be protected. Each unit consists of an outer housing which holds an inner bait-containing cartridge. Each unit is embedded to a depth of approximately 10 inches (25 cm) or less in the ground. A disadvantage of these systems is that each unit contains only one monitoring or bait delivery compartment to hold pesticide. Pest population monitoring and pesticide distribution is therefore limited by the number of baited cartridges that can be located by subterranean insects and the depth in the soil at which they are placed. No information of the stratification distribution of the pest can be obtained by monitoring with such a unit. Termite and ant colonies and other destructive pests are located deeper than 10 inches in the ground. In fact, vertical stratification appears to characterize ant and termite distribution patterns (Brühl et al. 1998, Traniello and Leuthold 2000; Vasconcelos and Vilhelna 2006, Yanoviak and Kaspari 2000). The footings of foundations are generally at least four feet deep and can make a structure vulnerable to pest attack if settlement cracks allow access. Current monitoring systems neglect to monitor pests and deliver toxic baits deeper in the soil, where ants and termites may search for food and shelter. As a result, these insects will avoid control and elimination. Deeper strata of insects can then serve as replacement populations of pests. Accordingly, apparatus and techniques to more comprehensively and reliably monitor the activity of termites, ants, and other subterranean insects, and for a targeted elimination remain a continuing demand.

There are no non-destructive techniques to monitor termite and ant activity at different levels below ground. As a result, the deeper subterranean pest fauna has been targeted infrequently and could evade control. Implementing a subterranean monitoring and pesticide delivery apparatus and can provide more comprehensive and efficacious pest management.

### SUMMARY OF THE INVENTION

The invention is a compartmentalized apparatus for monitoring, baiting and/or trapping subterranean insects such as termites that forage in a stratified subterranean environment and for administering pesticide to subterranean insects. The device is comprised of a housing unit with at least one opening adapted to being fixed in a vertical or horizontal position, such as in a vertical position in a subterranean environment requiring monitoring insect activity throughout their distribution in three dimensions. Aquatic organisms can also be monitored using the device, as can the distribution of chemicals at different levels in the soil over time in the same location.

In another embodiment, the compartmentalized apparatus can be placed horizontally in a house or other building structures to deal with a variety of insects that feed on widely different food sources. Such pests include different species of ants, termites, cockroaches, silverfish, flies, beetles, and moths, among other pests. The compartments may also disseminate substances to manage mold and other microbes together with their use to control insect pests.

The housing is designed so that there is one open end in said housing, wherein the housing has at least one opening for a cartridge, and the cartridge is removably receivable within said housing. The said cartridge having non-traversable compartments and at least one set of perforations to allow insects to enter into the apparatus, wherein said cartridge is operationally aligned with said housing for the perforations on the housing and the cartridge therein to coincide forming a through passage way from the exterior into the interior of the apparatus. The non-traversable compartments of the cartridge are separable and interchangeable, and a cartridge can comprised two or more such non-traversable compartments. For example, two to twenty, preferably two through ten, such as 3, 4, 5, 6 . . . 8, 9, 10 . . . 14, 15, . . . 20 and any number of compartments in between. The interior of each non-traversable compartment can be empty, or contain insert baits, and/or pesticide. A complete cartridge can comprise several non-traversable compartments, each having different contents to target specific pests.

One can placed the housing unit horizontally in a wall of a building structure and have an end cap that is positioned, for example, at the wall or the opening of a crawl space. This permits ready installation and removal of the cartridge. The housing and the cartridge can be any size, for example, four inches (10 cm) in length, 6 inches, and 8 inches. One can tailor baits and pesticides in each compartment for the particular pest one is interested in dealing with.

When used exterior of a building, the housing unit is typically placed vertically to target different insects at different soil levels, but it could also be place horizontally to monitor and control a variety of pests simultaneously.

### DETAILED DESCRIPTION OF THE DRAWINGS

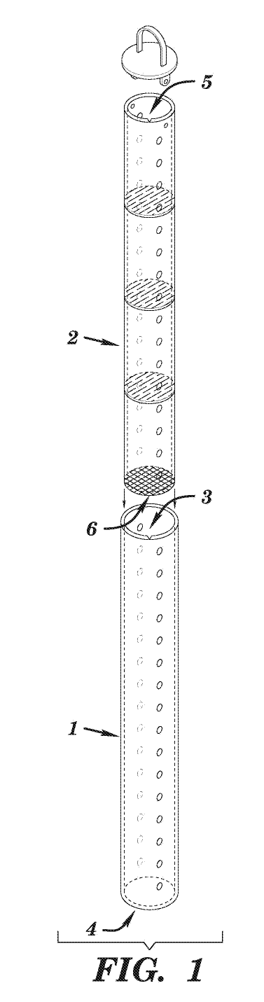

FIG. 1. Schematic diagram showing the components of the trap: an outer housing and an inner cartridge that is compartmentalized.

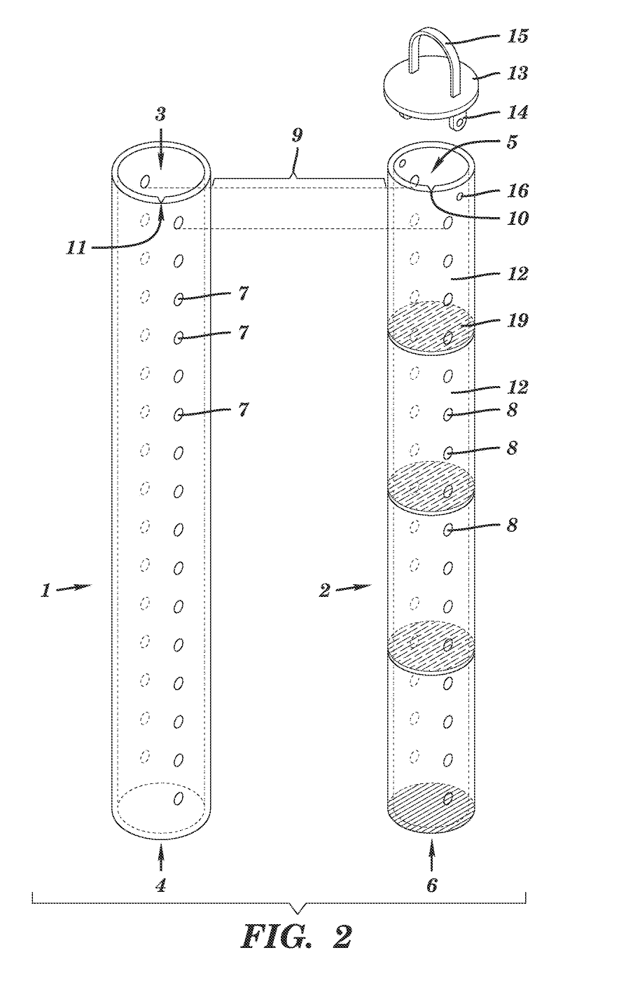

FIG. 2. Schematic diagram showing the components of the trap: an outer housing, an inner cartridge that is compartmentalized, with each compartment completely isolated from the adjoining compartment, separable and detachable from the other adjoining compartments, and a cap for keeping soil and water out of the cartridge and for easy retrieval of the inner compartmentalized cartridge.

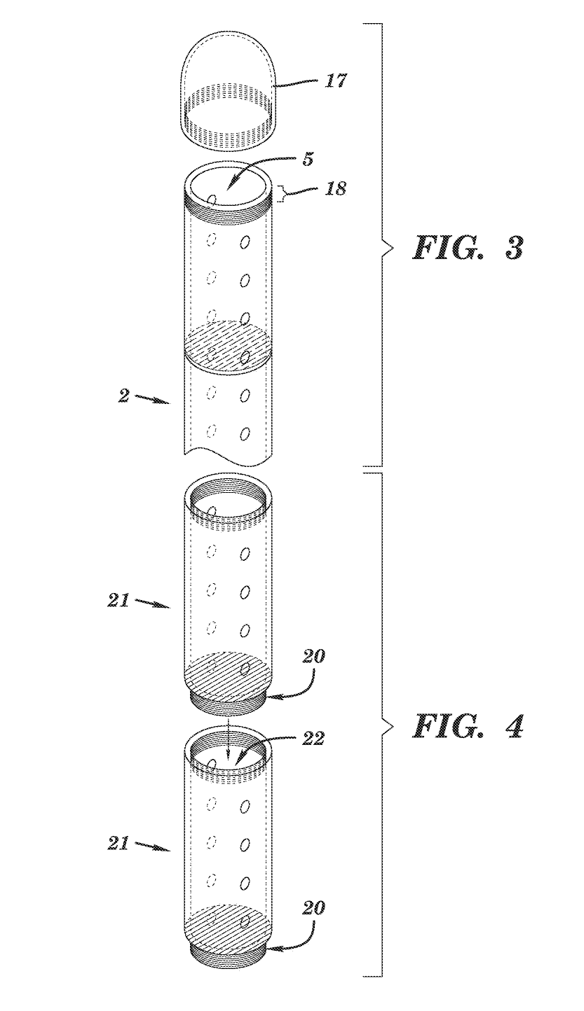

FIG. 3. Schematic diagram showing an alternate screw cap for the cartridge.

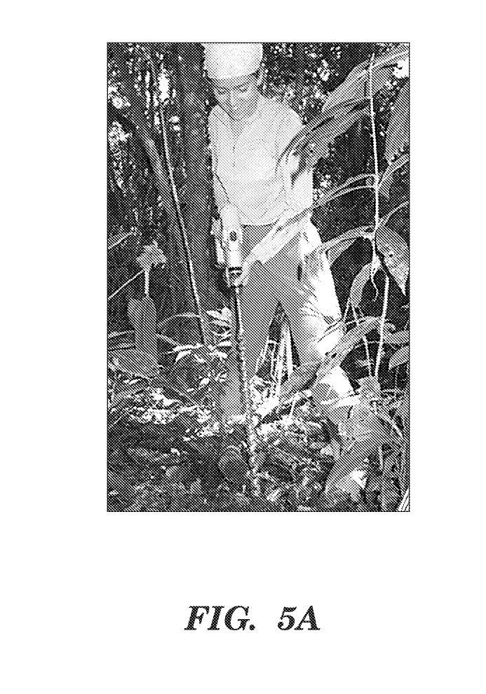

FIG. 4. Schematic diagram showing single, separated compartment components of the cartridge, which are threaded and can be joined to form a complete cartridge.

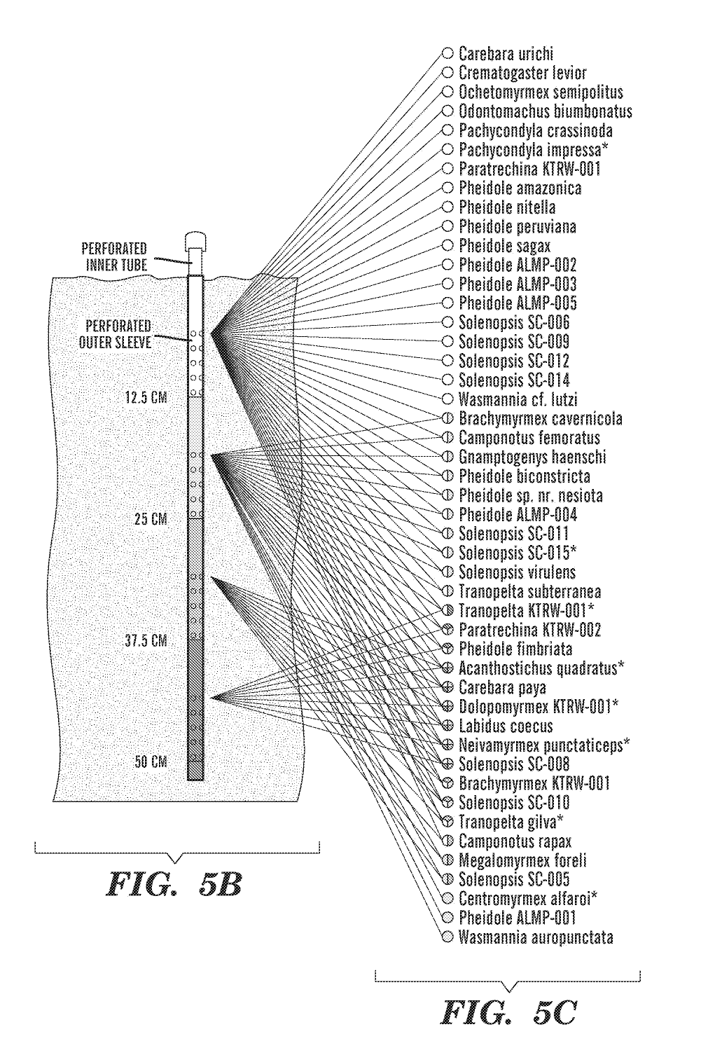

FIG. 5. An example of the application of the device to collect and monitor soil invertebrates, in this case the diversity of soil-dwelling Amazonian ants. (a) Preparing to implant the probe with a cordless hammer drill and auger. (b) Schematic of probe showing location of non-traversable bait compartments. (c) Ant species found in probes at different soil depth. Depth distribution: 12.5 cm, 25 cm, 37.5 cm and 50 cm below the surface. Not all species are common to all depths (e.g., only seven species were found at all four depths). Asterisks indicate species unique to monitors. Provisional morphospecies codes are given for unidentified ants.

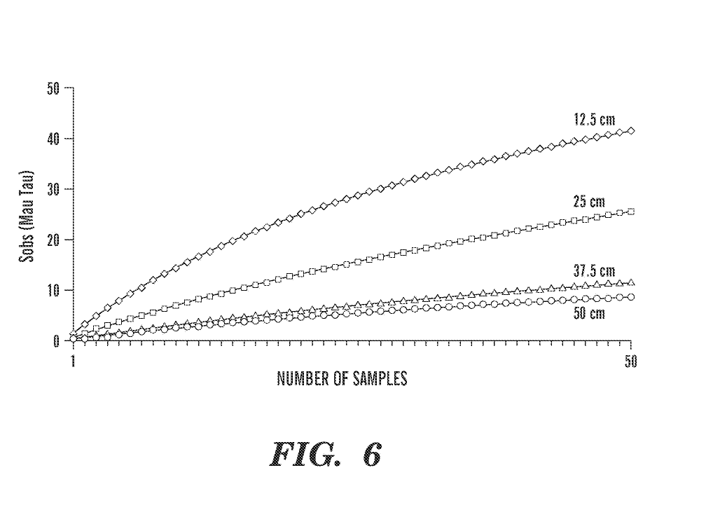

FIG. 6. Accumulation curves of species observed (Sobs Mau Tau) collected at the four probe depths.

### DETAILED DESCRIPTION OF THE INVENTION

In one embodiment, the apparatus comprise two cylindrical tubes 1 and 2 of different diameter sizes, wherein a smaller diameter cylindrical tube 2 is inserted into the chamber 3 (hollow) of the larger diameter cylindrical tube 1 forming a two-tubes-in-one apparatus (FIG. 1). Both cylindrical tubes 1 and 2 can have about the same length. The larger diameter cylindrical tube 1 has two open ends 3 and 4, one open end is situated at opposite ends of the tube. The larger diameter cylindrical tube 1 forms a housing unit for the smaller diameter cylindrical tube 2 (FIG. 1). The terms “larger diameter cylindrical tube” and “housing unit” are used interchangeable and they refer to the cylindrical tube 1. This housing unit is adapted so that if desired, it can be placed permanently in an environment in which population monitoring and/or management is desired and this housing unit is placed in a fixed position in the environment. For example, this housing unit can be placed vertically in the environment. The whole cylinder 1 is buried completely in the soil, completely immersed in water such that only the top open end 3 of the cylindrical tube 1 is exposed to air above and is visible, or embedded into the wall void of buildings. When placing the housing unit in the soil, a hole of a comparable size in diameter and depth is first created by drilling a hole in the soil, and then inserting the housing unit into the hole thus made. When placing the housing in an aquatic environment, the housing unit can be attached to floatation devices that are anchored to the bed of the body of water, e.g. pond, river, ocean, and estuary. The housing unit can be used in a wall of a home or other buildings. Typically the housing unit will be place horizontally in wall voids of building. In one embodiment, the inner diameter of the housing unit is two centimeters wide.

After the housing unit has been fixed in place, for example vertically or horizontally, a smaller diameter cylindrical tube 2 is inserted into the chamber 3 (hollow) of the housing unit 1 to form a tube-in-a-tube apparatus. The inner tube could also be inserted into a wall void without any form of housing. This smaller diameter cylindrical tube 2 forms a cartridge that is inserted into the housing unit 1 and is removable from the housing unit. The terms “smaller diameter cylindrical tube’ and “cartridge” are used interchangeable and they refer to the smaller cylindrical tube 2. This cartridge 2 is only slightly smaller in outer diameter compared to the inner diameter of the housing unit 1 in order for the cartridge to fits tightly inside the housing unit 1. Therefore this is no space gap between the walls of the cylindrical tubes. There are two ends in the cartridge, one end is the closed end 6 representing the bottom of the cartridge and the other end is an open end 5 representing the top end of the cartridge as the cartridge sits in the housing unit 1. The cartridge, with the closed end 6 leading, is inserted into the permanently placed housing unit via the top visible open end 3 of the housing unit. Since both the housing unit and the cartridge can have approximately the same length, the cartridge will insert fully into the housing unit and come to rest at the same level as the housing unit in the environment. In one embodiment, the inner diameter of the cartridge is 1.5 centimeters.

In one embodiment, both the housing unit and accompanying cartridge have perforations 7 and 8 on their respective walls along the length of the tubes for the insects such as subterranean insects, and other small organisms from the surrounding, e.g. soil (earth), to enter and leave the apparatus at liberty. The openings of the perforations on the housing unit 1 and cartridge 2 coincide 9 to form a through passage way from the exterior environment into the interior 12 of the cartridge. When placing the cartridge within the housing unit, the cartridge is rotationally orientated so that the marker 10 on the cartridge is aligned with the marker 11 on the housing unit. The alignment of the markers 9 and 10 brings the openings of the perforations of the housing unit 1 and the cartridge 2 to coincide. The perforations are there for the small organisms to leave the environment and enter the housing into the cartridge. The perforations can take the forms of many shapes and sizes, for example, circular holes, square holes, or rectangular slits. The perforations on the housing unit 1 and cartridge should be of the same shape and size. The openings of the perforations should not be too small to avoid clogging by soil and dirt particles. At the same time the perforations should also not too big to allow unrestricted inflow of soil and mud into the cartridge.

In one embodiment, the top open end 5 of the cartridge 2 is covered by a cap 13 to prevent access from the outside such as the inflow of rain water, sprinkler water, pond water, sea water, river water, insects, debris, dirt and soil from the top open. The cap 13 can be fastened to the cartridge by clips 14 on the side of the cap to the clip 16 on the side of the cartridge. The cap 13 is equipped with a handle 15 for lifting, removing, and extracting the cartridge from the housing unit when needed.

In another embodiment, the open top 5 of the cartridge 2 is closed by a screw cap 17 (FIG. 3) which also functions as a knob-like handle for removing the cartridge from the permanently placed housing unit. In this instance, the length of the cartridge 2 can be slightly longer in length than the housing unit 1, and the top of the cartridge is equipped with screw threads 18 for engaging the screw threads in the screw cap/handle 17.

Embodiments of the invention is an apparatus for monitoring small organisms in an environment, for baiting and trapping such small organisms present in the environment, and also for administering pesticide to such small organisms in the environment if the small organisms are harmful to human, properties, agriculture, and live stock. Environments that have small organisms and that are suited for the use of the apparatus described herein include but are limited to subterranean and aquatic environments, inside wall voids of building structures. Examples of subterranean environment are the soil in a rain forest, the soil of the compound surrounding a building, the sandy soil on a reclaimed land, and the muddy soil on an intertidal zone. Examples of aquatic environment are ponds, rivers, and aquaculture farms. The small organisms that can be monitored using the apparatus described herein include, but are not limited to insects, worms, fish fry, and plant and animal planktons.

Unless otherwise defined herein, scientific and technical terms used in connection with the present application shall have the meanings that are commonly understood by those of ordinary skill in the art. Further, unless otherwise required by context, singular terms shall include pluralities and plural terms shall include the singular.

Other than in the operating examples, or where otherwise indicated, all numbers expressing quantities of insect types and assemblage numbers should be understood as modified in all instances by the term “about.” The term “about” when used in connection with percentages may mean ±1%.

The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

It should be understood that this invention is not limited to the particular methodology and protocols, etc., described herein and as such may vary. The terminology used herein is for the purpose of describing particular embodiments only, and is not intended to limit the scope of the present invention, which is defined solely by the claims.

As used herein, the terms “apparatus” and “probe” refers to a two-in-one apparatus for monitoring, baiting, and controlling insects pest as described herein and are used interchangeably.

In one embodiment, the cylindrical interior 12 of the cartridge 2 is divided vertically into multiple compartments by several non-traversable dividers 19. The number of compartments can range from two and up to ten. Each compartment is distinct and physically separated from each other. Each compartment can be filled with bait material to lure the insects and small organisms of interest towards the interior 12 of the cartridge 2 or the compartment can be filed with pesticide against the insects and small organisms of interest. In certain instances, the compartment is left empty. Insects and small organisms wonder from the environment and enter into the interior of the cartridge via the coinciding perforations. Once inside the cartridge, the small organisms in one compartment cannot move within the interior of the cartridge to another compartment. Therefore, small organisms found in a particular compartment can indicate for example that such organisms are found at the depth or distribution corresponding to the relative vertical position of the compartment.

For certain pest species, such as ants, vertical stratification characterizes ant distribution patterns. The compartmentalization of the cartridge makes it easy and simple to figure out a distribution pattern for a pest or pests. The compartmentalized cartridge is ideal for periodical monitoring of the number and type of insects or small organisms that have wandered into the cartridge. The separate compartments allow for the use of multiple bait materials within a single apparatus to survey a number of different small organisms that have different distribution pattern in the environment. By the same token, the compartmentalized cartridge allow for the use of multiple chemical and non-chemical based pesticides within a single apparatus thus permitting the simultaneous deployment of a apparatus that controls different pests, thus targeting different pests with a single apparatus. The different baits or pesticide can be tailored to most effectively monitor and treat the pest problem. Moreover the compartmentalized cartridge is envisioned for simultaneously baiting, monitoring and delivering pesticide, or the combinations thereof, wherein some compartments can be carrying bait materials, some other compartments can be left empty, and the remaining compartments filled with pesticides.

In one embodiment, the cartridge can be used without the housing.

In another embodiment, the tube-in-a-tube apparatus or just the cartridge is buried horizontally below ground level or immersed in the aquatic environment.

In one embodiment, this tube-in-a-tube apparatus is buried vertically below ground level or immersed in the aquatic environment, with just one end of the apparatus minimally exposed above ground level or water level. Once positioned and placed on the ground or anchored in the aquatic environment, the housing unit remains in place is not moved nor removed. The compartmentalized cartridge on the other hand may be removed periodically to monitor the number and type of insects and small organisms that have wandered into the cartridge after a period of time the apparatus have been placed in the environment. Removal of the compartmentalized cartridge out of the housing unit is achieved by pulling the cartridge straight up and out of the housing unit from the exposed end of the two-tubes-in-one apparatus implanted on the ground using the handle 15 or the knob-like cap 17 outer sleeve. The housing unit remains in place. In one embodiment, the outside wall of the housing unit can have some ridges to provide grip and resistance for the housing unit to stay in place when the cartridge is being extracted.

In one embodiment, this tube-in-a-tube apparatus is placed horizontally in the wall void of homes and building structures for monitoring, baiting and pest control of insects such as ants, termites, cockroaches, bed bugs, mites and silverfish. The same device, multiply baited, can control both invertebrate and vertebrate pests. Wall voids are the spaces between wall studs that are usually filled with insulation. Insect pest such as ants use these avenues to enter and exit the building structure. An apparatus filled with bait can be used to monitor for signs of insect infestation in the building structure, and an apparatus filled with pesticide can be placed horizontally in the wall void to eliminate the insect pest. The housing unit is permanently placed in the wall void, while the removable compartmentalized cartridge is inserted into the horizontally placed housing unit. The end cap of the apparatus can be in the wall or an opening of a crawl space for easy access to the removable compartmentalized cartridge.

In one embodiment, the individual compartments of the cartridge can be separated from the other compartments, giving rise to single compartment component 21 of the cartridge 2 (FIG. 4). This allows independent access to the interior and contents of each compartment. Each compartment component 21 has a closed end that is threaded 20 to screwed into an open end 22 of an adjoining compartment component. The open end 22 is threaded on the inside to received the threads 20 of the adjoining compartment component. The joining of one adjoining compartment component to a second adjoining compartment component closes off the open end 22 and creates the non-traversable divider 19. Access to the interior is attained unscrewing the adjoining compartment components in a cartridge, and exposing the open end 22. Contents in the interior can be emptied out and new bait or bait with pesticide can be placed in the interior. Several compartment components can be adjoined to form a whole and long cartridge which is then inserted into the housing unit. An additional advantage of the separable compartments is that compartments can designated and dedicated permanently for pesticide use or baiting use or just surveillance use. Those compartments that are designated for pesticide use can be kept as such without having to be emptied and cleaned of the pesticide in order for baiting use. The different designated compartments can be mixed and match to form a whole cartridge for inserting into the housing unit depending on the need for monitoring or pest control and depending on the location of the insects.

An example of an embodiment of the invention is 50 cm long and 2.0 cm wide in outer diameter. The inner, smaller tube is divided vertically into four compartments at the 12.5, 25.0, 37.5, and 50 cm mark. This design is useful for surveying the distribution of subterranean insects.

In another embodiment, the invention is 10 cm (4 inches) long and 2.0 cm wide in outer diameter. The inner, smaller tube is divided vertically into four compartments at the 2.5, 5.0, 7.5, and 10 cm mark.

In one embodiment, the material suitable for the construction of the housing and cartridge is plastic which is both sufficiently strong, durable and yet light weight and relatively cheap to make. Examples of plastic include but are limited to polyethylene, polypropylene, polystyrene, high impact polystyrene, acrylonitrile butadiene styrene, polyethylene terephthalate, polyamides, poly(vinyl chloride), polyurethanes, polycarbonate, polyvinylidene chloride, and bayblend.

In one embodiment, the cross-sectional shape of the housing unit and the cartridge can be a square, a rectangle, an oval, or a polygon, in addition to a circle as described supra. Regardless of the shape, both the housing unit and the cartridge should have the same shape in order for the cartridge to slide into the hollow chamber of the housing unit. In addition, when the apparatus is to be implanted in the ground, a comparable drilling bit or hole drilling apparatus need to be use in order to produce a deep hole to accommodate the shape of the housing unit. After the housing unit is placed in the ground, the soil of the environment should be immediately adjacent to the outside wall of the housing unit and there should not be large air space between the outer wall of the housing unit and the soil.

In one embodiment, the apparatus is used on a site that requires surveillance or pest control. Several locations are selected in the surround ground area of the chosen site for the implantation of the subterranean apparatus. The locations should be at least 2 meters but not more than 20 meters apart from each other. A drill can be used to create deep holes in the ground to accommodate the subterranean apparatus, after which the housing unit of the subterranean apparatus is place completely into the hole with only the top open end barely visible at the top of the ground. The depth of the hole drilled should be just sufficient to accommodate the entire length of the housing unit. Care must be taken to ensure that the soil completely surrounds the housing unit along the entire length of unit in the ground and that there is not large air pockets between the housing unit and the soil. Once the housing unit is security in place in the ground, the compartmentalized cartridge, that is capped at the top open end 5, can be inserted bottom end 6 in first into the housing unit. The cartridge should come to rest when the bottom end 6 reaches the bottom end 4 of the housing unit and the cap of the cartridge should be visible above ground. The compartments of the cartridge can be filled wood chip or shredded paper or any paper, cardboard, sawdust or other cellulosic materials which serve as bait for termites or paper, cardboard, sawdust or other cellulosic material containing an active ingredient that kills ants, termites, silverfish and other pests. Examples of such active ingredients are boric acid, hexaflumuron, diflubenzuron, sulfluramid, and hydramethylnon.

The present invention can be defined by the following alphabetized paragraphs:
[A] An apparatus for controlling insects comprising:
   a. a housing with one open end having at least one set of perforation for insect movement into said apparatus; and
   b. a cartridge that is removably receivable within said housing, said cartridge having at least two non-traversable compartments and at least one set of perforation for insect movement into said apparatus, wherein said cartridge is operationally aligned with said housing for the openings of the perforations on the housing and the cartridge therein to coincide forming a through passage way from the exterior into the interior of the apparatus.
[B] The apparatus of according to paragraph [A], wherein the non-traversable compartments of a cartridge are separable and interchangeable.
[C] The apparatus of according to paragraph [A], wherein the number of non-traversable compartments ranges from two to ten.

This invention is further illustrated by the following example which should not be construed as limiting. The contents of all references cited throughout this application, as well as the figures and table are incorporated herein by reference.

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

### EXAMPLE

The inventors presents below an apparatus of the invention and the use of the invention to facilitate discovering and studying ants in the soil horizon. The apparatus of the invention was used for research on subterranean ant diversity in Amazonian Ecuador, comparing the effectiveness of our below-ground sampling technique with traditional collecting methods. Patterns of ant species richness in different strata were analyzed to demonstrate the utility of the invention in determining the uniqueness of the subterranean fauna.

Methods

Subterranean probe construction: a 50 cm-long plastic cylinder made from stock PVC pipe. Outer cylinder (2 cm outer diameter) is implanted in the ground after a hole of the same width and length is made using a portable power drill (DeWalt 2 1/2″ 24 v Cordless Drill/Hammer drill). Inner tube (1.5 cm outer diameter) fits tightly inside of outer sleeve and can be replaced without disturbance to the surrounding soil. Both cylinders are perforated with holes that allow ants to enter and feed at baits in each of four compartments, located 12.5, 25, 37.5 and 50 cm below the surface. Each section is physically separable and can be detached to allow the removal of ants. Ants visiting bait at one level cannot move within the probe to any other compartment.

Baited cylindrical probes were used to collect ants at different soil depths in primary terra firme rainforest at the Tiputini Biodiversity Station in Amazonian Ecuador. Ten probes, each separated by 20 meters (total=50 probe station samples) were implanted along each of five 200-meter transects separated by 200 meters. The probe consisted of two 50 cm-long plastic cylinders made from polycarbonate tubing. One cylinder (outer diameter=2.0 cm; inner diameter=1.5 cm) was implanted in the ground after a hole of the same diameter and length was drilled in the soil using a portable power drill (DeWalt 2.5 inch 24V cordless hammerdrill/24 inch auger). This outer cylinder received a second removable cylinder (inner diameter=1.0 cm; outer diameter=1.5 cm) fitted to its interior (FIG. 5). The inner probe could thus be removed and replaced to allow repeated monitoring without disturbing the surrounding soil. Both cylinders were perforated, allowing ants to occupy baits (protein and carbohydrate), in each of four compartments at depths of 12.5, 25, 37.5 and 50 cm below the surface. The perforations in the inner and outer cylinders were aligned by a notch in the top of the outer cylinder. Each bait compartment was physically separated and threaded to allow ants in adjacent compartments to be removed. Ants in one compartment could not move within the probe to another compartment. Therefore, the location of ants within the probe indicated the depth at which they search for food and/or nest. The soil surface surrounding an implanted probe was covered by plastic sheeting (approximately 1 m²) pegged tightly to the ground to prevent flooding. Probes were surveyed at 24, 48 and 72 hours after placement. At each census, ants present in the probe compartments were collected and their location recorded.

Subterranean survey. Five transects were set up in primary terra firme forest at the Tiputini Biodiversity Station in Amazonian Ecuador. Each transect was 200 meters long. Probe was inserted every 20 meters along each transect. 10 probes per transect, 5 transects, N=50. Each of the four probe compartments were filled with a combination of peanut butter, oil soaked bread, honey, and tuna. All specimens were identified to species or morphospecies and compared against type speciments at the Harvard Museum of Comparative Zoology when possible.

To examine the uniqueness of ants in the subterranean samples, the distribution of species found in probes (N=50) were compared with species collected by traditional sampling (Winkler and pitfall traps, surface baits, and hand collecting [N=60 samples each along 3 of the 5 transects] and canopy fogging [N=100 samples along 10 transects, including the 5 transects from this study). In total, we collected ˜113,000 ants from canopy fogging, hand collection, Winkler traps, baits, pitfall traps, and subterranean probes. All ants collected were identified to species or morphospecies and were compared with type specimens in the ant collection of the Harvard Museum of Comparative Zoology. All ants collected in the probes have been identified. To date, as many as 350 species/morphospecies in 64 genera were identified from all samples, with 17 genera yet to be examined. It is estimated that the complete inventory is at ˜500 species (Ryder Wilkie et al. in prep.).

Data Analyses. Species accumulation curves and Chao2 predictions of species richness were computed through EstimateS 7.0, using the MaoTau and Chao2Mean methods (Colwell 2004). Probe results were compared with other collection methods carried out in the same area [surface baits (N=60), direct band collecting (N=60), canopy fogging (N=100), pitfall traps (N=60), Winkler traps (N=60)].

Results

Forty seven species in 19 genera were collected from probes (FIG. 5). Acanthostichus quadratus, Centromyrmex alfaroi, Dolopomyrmex KTRW-001, Neivamyrmex punctaticeps, Pachycondyla impressa, Solenopsis SC-010, Solenopsis SC-015, Tranopelta gilva, and Tranopelta KTRW-001 were unique to probes. The mega diverse genus Pheidole comprised 25.5% of species collected in probes. Most species (78.7%) were collected within 24 h of placement; after 48 h seven additional species were collected, and three more species were found at 72 h. Maximum richness (42 species) occurred at 12.5 cm below ground, with 26, 12, and 9 species found at 25, 37.5, and 50 cm, respectively. Species richness at the two levels closest to the surface was most similar (44.7%), whereas species collected in the most distant probe compartments (12.5 and 50 cm) were the least similar (21.4%). Six species (12.8%) were found at all four depths, whereas 22 species (46.8%) were found at only one depth (FIG. 5). ANOSIM comparisons showed significant (p≦0.018) differences between species assemblages 12.5 cm below ground and each of the other three depths. Assemblages collected at other depths were not significantly different. Estimated similarity comparisons revealed the greatest difference in assemblages between 12.5 and 37.5 cm (0.4268), with 12.5 and 50 cm being the most similar (0.7655; Table1, ant assemblages of different probe levels). However, this result was due to the presence of one species, Tranopelta KTRW-001, at the 12.5 and 50 cm depths. Upon recalculation with estimated similarity treating Tranopelta KTRW-001 as an outlier, the greatest difference (0.4363) in assemblages was between 12.5 and 37.5 cm and assemblages found at 12.5 and 25 cm were the most similar (0.7532; Table1, with Tranopelta KTRW-001). Species accumulation rates decreased with depth (FIG. 6). All four curves showed a good fit to logarithmic models (R2≧0.8809).

At least nine species (19.2%) were unique to probes: these ants were not collected using any other method. Other species (Gnamptogenyshaenschi, Carebarapaya, Labiduscoecus, Solenopsis SC-012) were relatively common in probes but were only collected in a single non probe sample (Table2). ANOSIM calculations using data on genera revealed all ant assemblages differed significantly by collection method (p<0.001). This remained true even when specimens from 12.5 cm below ground were compared with pitfall and/or Winkler collections (p<0.001). Estimated similarity calculations of genera showed probe samples and samples obtained from other collection methods were generally more dissimilar than samples collected using other sampling methods were to each other (Table3). Similarity between probe samples and the other five methods employed ranged from 0.4591 (vs Winklers) to 0.7312 (vs hand collecting), while the similarity between samples using other collection methods ranged from 0.7062 (bait vs Winklers) to 1.0 (bait vs pitfall).

The probes are relatively easy to install in tropical soils with minimal disturbance to the surrounding environment. Because the bait compartments are physically separated, accurate information on the stratification of subterranean species can be acquired. The technique can also be used to sample other members of the soil invertebrate macrofauna and determine their distribution patterns. The probe therefore has wide-ranging potential applications in biotic inventories, behavior studies and ecological research on taxa that are among the most diverse and abundant members of the tropical rainforests (Eggleton 2000), could be sample to gain insight into their cryptic biology. The frequency of censuses, spatial distribution of probes, and bait materials can easily be adjusted to meet research goals.

Differences in the composition of species at the different probe levels (FIG. 5) suggest a vertical stratification in foraging. Ants found at all four levels may be more generalized in their foraging strategy and/or dominant, while ants found in only one level may have a more narrow range. Although assessing subterranean ant diversity in our probes may be complicated by the dominance of aggressive species, frequent bait inspections might yield species that arrive quickly but then retreat. Studies in different ecologically landscapes are also necessary to investigate the role that habitat plays in subterranean ant stratification For example, the water table at Tiputini is relatively high; in a dryer habitat it may be more common to find ants deeper in the soil.

The number of ant species collected, including new and rare forms unlikely to be found using other methods, was substantially increased using subterranean probes. One species, Dolopomyrmex n. sp., is a new species of a genus only recently described in the Southwestern United States (Deyrup and Cover, in press) that may be wholly hypogaeic (S. Cover pers. comm.). Centromyrmex and Acanthostichus appear to be obligate associates of termite nests and are likely predators (Hölldobler and Wilson 1990).

The ability to determine the spatial and temporal distribution of ants below the ground can enable significant evolutionary and ecological analyses. A recent molecular phylogeny of ants places the Leptanillinae—a clade of entirely subterranean species—at a pivotal position in ant evolution (Moreau et al. 2006). Assessing the diversity, relatedness and examining the sociobiology of this basal subfamily will require sampling methods that specifically target soil-dwelling forms. A focus on the subterranean fauna will also provide a more comprehensive understanding of the consequences of tropical forest modification in terms of loss of biodiversity and ecosystem functioning.

The references cited herein and throughout the specification are incorporated herein by reference.

### REFERENCES

Agosti D (ed.) (2000) Ants: Standard methods for measuring and monitoring biodiversity. Smithsonian Institution Press, Washington, D.C., 280 p.
Bestelmever, B. T., et al., Field techniques for the study of ground-dwelling ants. An overview, description and evaluation. Ants: Standard methods for measuring and monitoring biodiversity. Washington, D.C., Smithsonian Institution Press 122:-144.
Brühl C A, Gunsalam G and Linsenmair K E (1998) Stratification of ants (Hymenoptera, Formicidae) in a primary rain forest in Sabah, Borneo. J. Trop. Ecol. 14:285-297.
Colwell, R. K. (2004) EstimateS: Statistical Estimation of Species Richness and Shared Species from Samples, Version 7.5.
Eggleton P (2000) Global patterns of termite diversity. In: Abe T, Bignell D and Higashi M (ed), Termites: Evolution, sociality, symbioses, ecology. Kluwer Academic Publications, Dordrecht, 25-54.
Fowler H G, Delabie H J C and Moutinho P R S (2000) Hypogaeic and epigaeic ant (Hymenoptera. Formicidae) assemblages of Atlantic coastal rainforest and dry mature and secondary Amazon forest in Brazil: Continuums or communities. Tropical Ecol. 41; 73-80.
Freclauan, D. W. (1994). Life in the soil—soil biodiversity: Its importance to ecosystem processes. Repeat of a workshop held at the Natural History Museum, London England, London Natural History Museum.
Hölldobler B and Wilson EO (1990) The ants. Harvard University Press, Cambridge, Mass.
Moreau C S, Bell C D, Vila R, Archibald S B and Pierce N E (2006) Phylogeny of the ants: Diversification in the age of angiosperms. Science 312:101-104.
O'Donnell S, Karpari M and Lattke J (2005) Extraordinary predation by the neotropical army ant Cheliomyrmex andicola: Implications for the evolution of the army any syndrome. Biotropica 37:706-709.
Vasconcelos H L and Vilhena J M S (2006) Species turnover and vertical partitioning of ant assemblages in the Brazilian Amazon: A comparison of forests and savannas. Biotropica 38:100-106.
Yanoviak S P and Kaspari M (2000) Community structure and the habitat templet: Ants in tropical forest canopy and litter. Oikos 89:259-266.

TABLE 1

| | Ant assemblages of different probe levels | | | | Without Tranopelta KTRW-001 | | | |
|---|---|---|---|---|---|---|---|---|
| | 12.5 cm | 25 cm | 37.5 cm | 50 cm | 12.5 cm | 25 cm | 37.5 cm | 50 cm |
| 12.5 cm | 1.0000 | | | | 1.0000 | | | |
| 25 cm | 0.7377 | 1.0000 | | | 0.7532 | 1.0000 | | |
| 37.5 cm | 0.4268 | 0.6470 | 1.0000 | | 0.4363 | 0.6470 | 1.0000 | |
| 50 cm | 0.7655 | 0.5149 | 0.7165 | 1.0000 | 0.6250 | 0.5149 | 0.7425 | 1.0000 |

TABLE 2
The 47 ant species collected in subterranean probes and their presence in other sampling methods

| | | Found only | Hand | | | | Canopy |
|---|---|---|---|---|---|---|---|
| Subfamily | Species | in probe | collecting | Bait | Pitfall | Winkler | fogging |
| Cerapachyinae | Acanthostichus quadratus | • | | | | | |
| Ecitoninae | Labidus coecus | | •^{a} | | | | |
| | Neivamyrmex punctaticeps | • | | | | | |
| Ectatomminae | Gnamptogenys haenschi | | | | •^{a} | | |
| Formicinae | Brachymyrmex cavernicola | | • | | | • | •^{a} |
| | Brachymyrmex KTRW-001 | | • | | | • | |
| | Camponotus femoratus | | • | • | • | • | • |
| | Camponotus rapax | | •^{a} | | •^{a} | | |
| | Paratrechina KTRW-001^{b} | | | | | | |
| | Paratrechina KTRW-002^{b} | | | | | | |
| Myrmicinae | Carebara paya | | | | | | •^{a} |
| | Carebara urichi | | • | | •^{a} | •^{a} | |
| | Crematogaster levior | | • | • | • | • | • |
| | Dolopomyrmex KTRW-001 | • | | | | | |
| | Megalomyrmex foreli | | • | • | • | • | • |
| | Ochetomyrmex semipolitus | | | •^{a} | • | • | |
| | Pheidole amazonica | | • | •^{a} | | • | |
| | Pheidole biconstricta | | • | •^{a} | • | • | • |
| | Pheidole fimbriata | | •^{a} | | | • | |
| | Pheidole nitella | | • | • | • | • | |
| | Pheidole peruviana | | •^{a} | •^{a} | | | |
| | Pheidole sagax | | •^{a} | •^{a} | •^{a} | • | |
| | Pheidole sp. nr. nesiota^{b} | | | | | | |
| | Pheidole ALMP-001^{b} | | | | | | |
| | Pheidole ALMP-002^{b} | | | | | | |
| | Pheidole ALMP-003^{b} | | | | | | |
| | Pheidole ALMP-004^{b} | | | | | | |
| | Pheidole ALMP-005^{b} | | | | | | |
| | Solenopsis SC-005 | | | •^{a} | | •^{a} | • |
| | Solenopsis SC-006 | | • | • | • | • | • |
| | Solenopsis SC-008 | | • | • | • | • | •^{a} |
| | Solenopsis SC-009 | | | • | • | • | • |
| | Solenopsis SC-010 | • | | | | | |
| | Solenopsis SC-011 | | | •^{a} | • | • | •^{a} |
| | Solenopsis SC-012 | | | | | •^{a} | |
| | Solenopsis SC-014 | | | | •^{a} | •^{a} | |
| | Solenopsis SC-015 | • | | | | | |
| | Solenopsis virulens | | • | • | •^{a} | • | |
| | Tranopelta gilva | • | | | | | |
| | Tranopelta KTRW-001 | • | | | | | |
| | Tranopelta subterranea | | • | • | | • | |
| | Wasmannia auropunctata | | • | • | • | • | • |
| | Wasmannia cf. lutzi | | • | •^{a} | • | • | • |
| Ponerinae | Centromyrmex alfaroi | • | | | | | |
| | Odontomachus biumbonatus | | •^{a} | | •^{a} | | |
| | Pachycondyla crassinoda | | •^{a} | • | • | | |
| | Pachycondyla impressa | • | | | | | |

Species found in probes are compared to those collected using traditional sampling methods.
^{a}indicates collection in only 1 sample (within each method).
^{b}denotes genera for which species identifications (in non-probe samples) are pending. Some Pheidole minor workers could not be identified because no corresponding major worker was collected.

TABLE 3
Estimated similarity between assemblages of ant genera
collected using different techniques

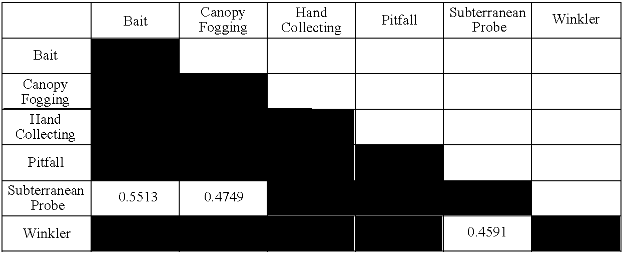

What is claimed:

1. An apparatus for controlling insects comprising:
a. a housing with one open end having at least one set of perforation for insect movement into said apparatus; and
b. a cartridge that is removably receivable within said housing, said cartridge having at least two non-traversable compartments and at least one set of perforation for insect movement into said apparatus, wherein said cartridge is operationally aligned with said housing for the openings of the perforations on the housing and the cartridge therein to coincide forming a through passage way from the exterior into the interior of the apparatus.

2. The apparatus of according to claim 1, wherein the non-traversable compartments of a cartridge are separable and interchangeable.

3. The apparatus of according to claim 1, wherein the number of non-traversable compartments ranges from two to ten.
